(19) United States
(12) Patent Application Publication
(10) Pub. No.: US 2024/0285142 A1
(43) Pub. Date: Aug. 29, 2024

(54) METHOD FOR COLLISION-FREE WALL-CLEANING AND/OR EDGE-CLEANING

(71) Applicant: BSH Hausgeräte GmbH, München (DE)

(72) Inventors: Frank Schnitzer, Bad Neustadt (DE); Kristina Daniel, Bad Neustadt (DE)

(21) Appl. No.: 18/582,914

(22) Filed: Feb. 21, 2024

(30) Foreign Application Priority Data
Feb. 23, 2023 (DE) 10 2023 201 679.6

(51) Int. Cl. A47L 9/28; A47L 9/04; A47L 11/40

(52) U.S. Cl. CPC A47L 9/2852; A47L 9/0488; A47L 11/4061; A47L 2201/04

(57) ABSTRACT

A method for collision-free wall-cleaning and/or edge-cleaning by a mobile, self-driving appliance, in particular a floor cleaning appliance for autonomous processing of floor surfaces, such as a robotic vacuum cleaner and/or a sweeping and/or mopping robot, which includes a laterally disposed wall tracking sensor and a distance sensor, includes travelling along a wall section at a first distance determined by measured values of the wall tracking sensor, and simultaneously measuring a second distance to the wall using the distance sensor. A difference is determined between the distance values of the wall tracking sensor and the distance sensor by a computer facility of the appliance. A collision-free distance value with respect to the wall section is determined as a function of the difference by the computer facility. Subsequent cleaning journeys are controlled by a closed-loop distance control as a function of the collision-free distance value that is determined.

### CROSS-REFERENCE TO RELATED APPLICATION

This application claims the priority, under 35 U.S.C. § 119, of German Patent Application DE 10 2023 201 679.6, filed Feb. 23, 2023; the prior application is herewith incorporated by reference in its entirety.

### FIELD AND BACKGROUND OF THE INVENTION

The invention relates to a method for collision-free wall-cleaning and/or edge-cleaning by using a mobile, self-driving appliance, in particular a floor cleaning appliance for autonomous processing of floor surfaces, such as a robotic vacuum cleaner and/or a sweeping and/or mopping robot, having a wall tracking sensor and a distance sensor.

Mobile, self-driving appliances, such as robotic vacuum cleaners for example, have the task of cleaning an entire floor area as autonomously as possible. In particular, robotic vacuum cleaners are constructed to relieve their users of the task of regularly removing dust and dirt from the floor. Particular attention is paid to cleaning along walls. A robotic vacuum cleaner should be able to travel very close to existing walls or other objects in order to bring its cleaning elements, such as sweeping brushes or a suction mouth, into close proximity to wall edges and thus avoid floor areas remaining uncleaned. If the robotic vacuum cleaner is unable to detect its surroundings at a low height level using sensors, there is a risk that the robotic vacuum cleaner will bump into obstacles such as baseboards while travelling close to walls.

For cleaning corners and edges, a rotating side brush is usually attached to a front corner of the housing of the appliance and the rotating side brush sweeps dust and dirt along the edge to the center of the appliance when cleaning along walls. However, such a side brush has little effect on carpets, for example, since the dirt particles get caught in the carpet fibers. Due to the uneven surface of the carpets, it is usually not possible to achieve a sweeping effect. As a result, there is a risk that dirt and dust will remain visible on the carpet. In order to remove dust from the carpet as effectively as possible, it is advantageous to sweep the carpet using a suction mouth and a brush roller of the appliance, since the suction effect then supports dust removal.

Due to the side brush, however, the suction mouth of the appliance is often disposed asymmetrically and in particular on a side brush side further away from the side of the appliance than from a side that is opposite the side brush side. That results in sub-optimal carpet cleaning on the side brush side.

It is therefore advantageous not to allow the appliance to travel with its side brush side along a wall for cleaning but rather with the opposite side. However, the appliance often does not have a wall tracking sensor on that side, which disadvantageously increases the risk of collisions with obstacles and walls. For that reason, the appliance usually moves during its cleaning journey in such a way that the side-facing wall tracking sensor can detect the wall.

In order to allow the appliance to travel along the wall with as much precision as possible, so as on the one hand not to risk collisions with a baseboard, for example, and on the other hand to clean as far as possible up to the edge, suitable sensors are required on the appliance. For cost reasons, however, it is advantageous to install as few wall sensors as possible, i.e. in particular not to install a second wall tracking sensor on the opposite side. However, that makes it more difficult to track a wall in different directions of travel, in particular to travel in both directions along edges and walls, with a low risk of collision while simultaneously effectively cleaning the edges or walls.

### SUMMARY OF THE INVENTION

It is accordingly an object of the invention to provide a method for collision-free wall-cleaning and/or edge-cleaning, which overcomes the hereinafore-mentioned disadvantages of the heretofore-known methods of this general type and which, in particular, ensures that it is possible to travel in both directions along edges and walls, with a low risk of collision while simultaneously effectively cleaning the edges or walls.

With the foregoing and other objects in view there is provided, in accordance with the invention, a method for collision-free wall-cleaning and/or edge-cleaning by using a mobile, self-driving appliance, in particular a floor cleaning appliance for autonomous processing of floor surfaces, such as a robotic vacuum cleaner and/or a sweeping and/or mopping robot, which includes a laterally disposed wall tracking sensor and a distance sensor, comprising the following steps: travelling along a wall section at a first distance, which is determined by way of measured values of the wall tracking sensor; simultaneously measuring a second distance to the wall using the distance sensor; determining a difference between the distance values of the wall tracking sensor, i.e. the first distance, and the distance sensor, i.e. the second distance, by using a computer facility of the appliance; and determining a collision-free distance value with respect to the wall section as a function of this difference by using the computer facility, wherein subsequent cleaning journeys are controlled by a closed-loop distance control as a function of the collision-free distance value that is determined.

Advantageous embodiments and developments of the invention are the subject matter of the subclaims.

In the present case, the appliance can therefore travel in both directions along edges and walls using only a single wall tracking sensor without causing a risk of collision while simultaneously efficiently cleaning edges, in that a closed-loop distance control is determined which is based, inter alia, on past wall tracking sensor measured values. In addition to the wall tracking sensor, the appliance has a distance sensor that can measure the surroundings with a 360° field of vision in a horizontal plane just above the appliance housing. The distance sensor, preferably a LIDAR sensor, is provided so as to detect walls, objects and other obstacles at approximately a structural height of the appliance.

The wall tracking sensor is positioned in the main direction of travel of the appliance, in particular on a side brush side of the appliance directly in front of the auto-drives of the appliance. This means that the wall tracking sensor is positioned significantly lower than the distance sensor and can also be inclined downwards. In this way, the wall tracking sensor can detect objects that are just above the floor. The wall tracking sensor has a short maximum measuring distance, so it is preferably used in the immediate vicinity of walls or objects.

The first time the appliance passes over the wall section with the side brush side on which the wall tracking sensor is also located, the appliance maintains the first distance to the wall or objects or the baseboard in accordance with the measured values of the wall tracking sensor. The distance sensor simultaneously measures the second distance to the wall so that the distance of the appliance from the wall can be determined for each area of the wall. Assuming that the circumstances at the wall no longer change, the measured values that are determined can be used to determine a suitable collision-free distance value on which subsequent journeys of the appliance are based, in particular regardless of the direction of travel of the appliance.

A mobile, self-driving appliance is to be understood in particular as a floor cleaning appliance that can autonomously process floor surfaces in the household sector, for example. This includes, among other things, robotic vacuum cleaners and/or sweeping and/or mopping robots. These appliances preferably work during operation (cleaning mode) without or with as little user intervention as possible. For example, the appliance moves automatically into a predefined room to clean the floor according to a predefined and programmed method strategy.

In order to take into account any individual environmental characteristics, an exploration journey is preferably carried out using the mobile, self-driving appliance. In particular, an exploration journey is understood as an exploratory journey that is suitable for exploring a floor surface that is to be processed for obstacles, spatial distribution and the like. The aim of an exploration journey is in particular to be able to assess and/or visualize the conditions of the floor processing area that is to be processed.

After the exploration journey, the mobile, self-driving appliance knows its surroundings and can pass them on to the user in the form of a map of the surroundings, for example in an app (cleaning app) on a mobile device. In the map of the surroundings, the user can be given the opportunity to interact with the mobile, self-driving appliance. The user can view information on the map of the surroundings and change and/or adapt it if necessary.

A map of the surroundings is to be understood in particular as any map that is suitable for depicting the surroundings of the floor processing area with all its obstacles and objects. For example, the map of the surroundings shows the floor processing area with the furniture and walls contained therein in the form of an outline.

The map of the surroundings with the obstacles is preferably displayed in an app on a portable additional device. This serves in particular to visualize a possible interaction for the user. In the present case, an additional device is to be understood in particular as any device that is portable for a user, that is disposed outside the mobile, self-driving appliance, in particular is external and/or differentiated from the mobile, self-driving appliance, and is suitable for displaying, providing, transmitting and/or transferring data, such as a cellphone, a smartphone, a tablet and/or a computer or laptop.

The app, in particular a cleaning app, is installed on the portable auxiliary device, which is used for communication between the mobile, self-driving appliance and the auxiliary device and, in particular, enables visualization of the floor processing area, i.e. the living room to be cleaned or the dwelling or living area to be cleaned. The app preferably shows the user the area to be cleaned as a map of the surroundings.

Obstacles are understood to be any objects and/or items that are located in a floor processing area, for example lying or standing there, and influence, in particular hinder and/or interfere with the processing by the mobile, self-driving appliance, such as furniture, walls, curtains, carpets and the like.

A baseboard is, in particular, a molding that runs on the floor along a wall so as to provide a finish between the floor and the wall. The baseboard is detected by the wall tracking sensor of the appliance. The wall tracking sensor is preferably suitable for detecting obstacles and, in particular, baseboards just above the floor, preferably at floor level.

Preferably, the distance sensor is a LIDAR sensor and/or a laser tower that samples or scans its surroundings in a horizontal plane by rotating 360°. In particular, the distance sensor emits measuring beams, especially laser beams, at regular intervals, which are used for distance measurement. The distance sensor is rotated about an axis of rotation, in particular about a z-axis, relative to the appliance housing and is driven by a motor.

A wall tracking sensor is, in particular, a distance sensor that is suitable for detecting objects, obstacles, objects and/or walls that are close to the sensor and close to the floor, especially those that are close to the floor. In so doing, the wall tracking sensor has a short maximum measuring distance. Preferably, the wall tracking sensor is attached to the side brush side of the appliance.

A wall section is understood in particular as a section of a detected wall that includes, for example, a straight configuration of the wall. Preferably, different wall sections that are disposed next to each other form a complete wall or a surrounding wall that delimits the room. The method in accordance with the invention can be carried out on each of the different wall sections, so that each wall section is assigned its own collision-free distance value and, in particular, its own closed-loop distance control. Alternatively, it is also possible to carry out the method in a purposeful manner only on predetermined or selected wall sections, so that the remaining wall sections are not assigned a collision-free distance value and, in particular, are not assigned a closed-loop distance control.

The first distance to the wall is in particular the distance between the appliance and the wall section or baseboard or obstacle, which is determined by way of measured values from the wall tracking sensor so that the appliance does not collide with the wall, baseboard or obstacles, but still allows wall-or edge-cleaning as close as possible. This ensures collision-free cleaning close to the wall.

The second distance to the wall is in particular the distance between the appliance and the wall section, which is determined by way of measured values of the distance sensor, and in particular detects the wall or the wall section. The second distance is greater than the first distance when travelling along a wall which has a baseboard.

A closed-loop distance control is understood, in particular, as a closed-loop control with regard to a minimum distance to a wall or objects, which must be maintained in order to avoid collisions with the appliance, but at the same time as close to the wall as possible in order to enable cleaning over as much of the entire surface and as close to the wall or obstacle as possible.

In an advantageous embodiment, the appliance only has the wall tracking sensor on one side. In particular, the appliance does not have a wall tracking sensor on the opposite side. Based on the collision-free distance value that is determined, a single wall tracking sensor is sufficient to ensure collision-free wall-cleaning and edge-cleaning. A second wall tracking sensor is advantageously superfluous, which advantageously results in cost savings.

In a further advantageous embodiment, the collision-free distance value or the closed-loop distance control results from the determined minimum distances of the measurements of the wall tracking sensor and the distance sensor. When travelling along a wall, the wall tracking sensor measures the first distance to objects that are close to the floor, such as baseboards. The distance sensor measures the second distance to the wall. The difference between the distance values can be used to determine the minimum distance the appliance must be from the wall in order to avoid colliding with objects close to the floor, even if a wall tracking sensor is not used.

In a further advantageous embodiment, the collision-free distance value is recorded in a map of the surroundings or a grid map. In particular, assuming that the circumstances on the wall, such as existing baseboards, objects placed there or the wall itself, no longer change, the minimum distances that are determined, i.e. the collision-free distance value, can be recorded in the existing map of the surroundings or map of obstacles.

In a further advantageous embodiment, revised boundary lines or delimiting grid lines that the appliance should not pass over are recorded in the map of the surroundings. This means that new edges or lines which must not be crossed by the appliance are drawn in the map of the surroundings based on the collision-free distance value. This basically corresponds to the principle of so-called no-go lines or no-go areas. Areas in which the wall tracking sensor has not detected any objects close to the floor remain unchanged on the map of the surroundings. Accordingly, corresponding grid lines that indicate objects at floor level can be marked as impassable or assigned a factor that indicates an object or an area that cannot be passed through in the grid map (occupancy grid map), which is available to the appliance like a map of the surroundings after the exploration trip. In this case too, the appliance will no longer travel through these grid lines.

Alternatively, when using the closed-loop distance control, an increased minimum distance can be set for the areas that are previously detected by the wall tracking sensor so that an increased value for an underlying parameter is used when a closed-loop controller is activated in these areas.

In a further advantageous embodiment, only the distance sensor is used for the closed-loop distance control during the subsequent cleaning journeys. Preferably, a measurement is performed by the wall tracking sensor on an outward journey, and on a return journey the closed-loop distance control is based on the measurements of the distance sensor.

If the determined collision-free distance value is stored, for example, in the map of the surroundings for the appliance, the appliance accesses the adapted map of the surroundings or the map of the surroundings that is expanded with the collision-free distance value or the adapted distance values. The distance sensor is used to maintain the distance to the wall or the detected obstacles in such a way that the areas previously recognized as objects close to the floor are omitted as close as possible to the object, wherein no collision occurs even without a wall tracking sensor, while the appliance still moves as close as possible to the wall or the objects. In particular, this allows the appliance to move as close as possible to the wall even without direct use of the wall tracking sensor and to clean areas as close to the wall as possible without being exposed to the risk of collisions.

In particular, during a first journey the appliance measures the first distance to objects that are close to the floor using the wall tracking sensor and simultaneously measures the second distance to the wall using the distance sensor. Based on this, for example, the map of the surroundings of the appliance is adapted and areas that cannot be passed are now recorded in the map of the surroundings. During a second journey along the same wall in the opposite direction to the first journey, the appliance can assume the corresponding necessary or preferred distances to the wall based solely on the measured values of the distance sensor to the wall and based on the adapted map of the surroundings. The second journey is preferably a mirror-inverted copy of the first journey.

In a further advantageous embodiment, the outward and return journeys take place in areas in which a floor carpet is adjacent to a wall. Preferably, the appliance has a carpet sensor with which it can recognize when it is on a carpet. If the appliance marks on its map of the surroundings recognized carpet areas or carpet areas which are input by the user in the app, it can restrict travel in both directions along the wall to those areas.

In a further advantageous embodiment, the collision-free distance value is determined during an exploratory journey of the appliance. In particular, the measured values of the wall tracking sensor are not re-evaluated and the map of the surroundings is not adapted for each cleaning journey. Although the appliance can continue to analyze the measured values of the wall tracking sensor during each cleaning run along the wall, the map of the surroundings does not necessarily have to be adapted each time the environmental conditions are the same.

In a further advantageous embodiment, the collision-free distance value is not determined during cleaning journeys of the appliance, unless a change is determined compared to an existing map of the surroundings. If the appliance detects a collision with an object close to the wall using one of its sensors, and thus determines a change compared to the map of the surroundings, the collision-free distance value in this wall section is determined again, including an adaptation of the map of the surroundings.

By determining the collision-free distance value, the side brushes and the suction mouth can be used in a purposeful manner, particularly for appliances having an asymmetrically positioned suction mouth, in order to reduce areas on the wall that have not been cleaned. This allows the advantages of different cleaning methods, for example cleaning with or without side brushes, to be utilized. A high quality of floor cleaning with a simultaneous low risk of collision and cost-efficient realization are thus advantageously made possible.

Other features which are considered as characteristic for the invention are set forth in the appended claims.

Although the invention is illustrated and described herein as embodied in a method for collision-free wall-cleaning and/or edge-cleaning, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1A and 1B are respective diagrammatic, perspective and bottom-plan views of an exemplary embodiment of a mobile, self-driving appliance which is suitable for a method in accordance with the invention for collision-free wall-cleaning and/or edge-cleaning;

FIGS. 2A and 2B are respective perspective views of an exemplary embodiment of a mobile, self-driving appliance which is suitable for a method in accordance with the invention for collision-free wall-cleaning and/or edge-cleaning;

FIGS. 3A and 3B are respective perspective views of an exemplary embodiment of a mobile, self-driving appliance which performs a first method step of the method in accordance with the invention for collision-free wall-cleaning and/or edge-cleaning;

FIG. 4 includes two top-plan views of a map of the surroundings or a grid map, which is adapted in a further method step of the method in accordance with the invention for collision-free wall-cleaning and/or edge-cleaning based on the collision-free distance value that is determined;

FIGS. 5A and 5B are respective perspective views of an exemplary embodiment of a mobile, self-driving appliance which performs a further method step of the method in accordance with the invention for collision-free wall-cleaning and/or edge-cleaning; and

FIG. 6 is a flow chart relating to an exemplary embodiment of a method according to the invention.

### DETAILED DESCRIPTION OF THE INVENTION

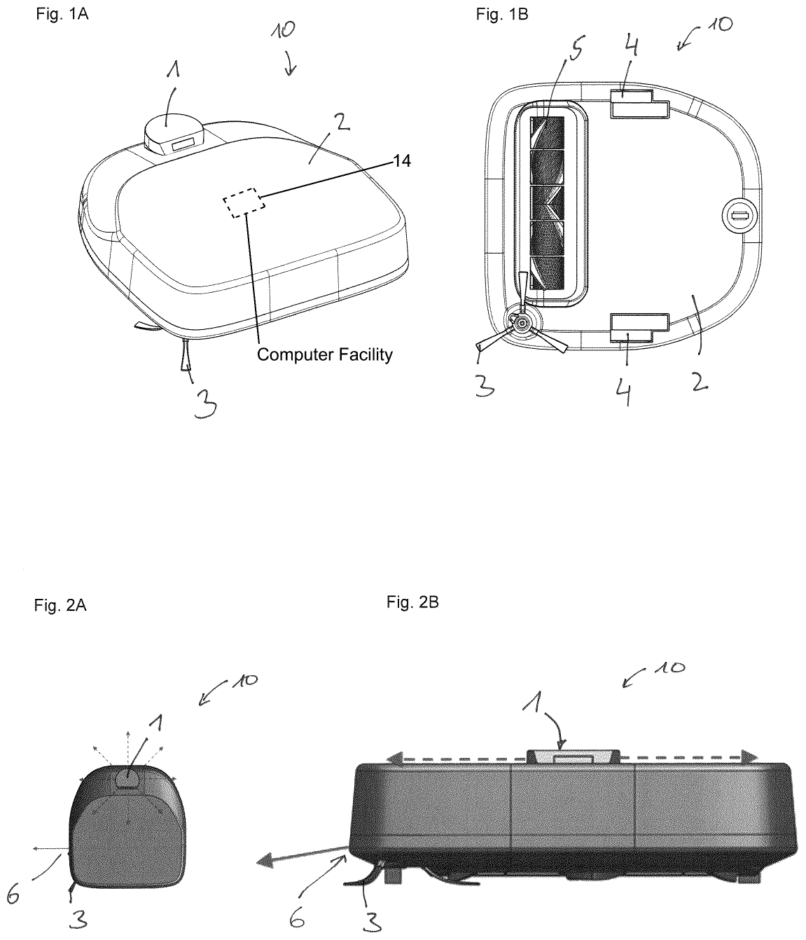

Referring now to the figures of the drawings in detail and first, particularly, to FIG. 1 thereof, there is seen a diagrammatic, three-dimensional view of a mobile, self-driving appliance 10, which is in particular a robotic vacuum cleaner. FIG. 1B shows a bottom view of the appliance 10 of FIG. 1A. The robotic vacuum cleaner has a distance sensor, in particular a LIDAR sensor 1, on its upper side in a rear area, which is disposed on an appliance body 2 of the appliance 10. The LIDAR sensor 1 detects a horizontal plane in the surroundings above the appliance 10 and can thus measure distances to walls or other objects.

A side brush 3, which is disposed at a front corner of the appliance 10, is intended to sweep dust and dirt into a suction mouth 5, in which a brush roller is disposed and positioned in front of drive wheels 4 of the appliance 10. Due to the one-sided arrangement of the side brush 3, the suction mouth 5 is disposed off-center on the housing body 2. On the side of the appliance 10 which has the side brush 3, the suction mouth 5 is in particular at a greater distance from the edge of the housing body than on the opposite side that does not have a side brush 3.

For effective wall-cleaning and edge-cleaning on hard floors, the side brush 3 sweeps the dust and dirt towards the center of the appliance, where it is sucked into the suction mouth 5. However, the side brush 3 has little effect on carpets, since dirt particles can get caught in the carpet fibers and no sweeping effect is achieved due to the uneven carpet surface. In order to remove dust from the carpet, it is effective to sweep over the carpet with the suction mouth 5 and the brush roller to optimize the suction effect. Due to the side brush 3, the suction mouth 5 is disposed asymmetrically, which means that when traveling along a wall with the right-hand side along the wall when cleaning carpets, optimum dust and dirt removal cannot be guaranteed. On carpets, it is therefore expedient to allow the appliance 10 to travel with its side which does not have a brush along the wall, since this brings the suction mouth 5 closer to the wall.

In order to be able to take into account objects that are close to the floor, such as baseboards, when travelling along walls, a wall tracking sensor 6 is installed on the right-hand side in the direction of travel, as shown in FIGS. 2A and 2B. This wall tracking sensor 6 measures the lateral distance to a wall or to the objects that are close to the floor. For example, a baseboard on a wall, from which the appliance 10 is at a smaller distance than to the wall itself, can be detected by the wall tracking sensor, which renders it possible to control an optimum distance between the appliance 10 and the wall. In order for the appliance to also be able to travel in a collision-free manner with its side which does not have a side brush and which does not have a wall tracking sensor along walls and objects that are close to the floor, an optimum distance to the wall is determined by the wall tracking sensor during a first journey along the wall, a closed-loop distance control is performed and the closed-loop distance control is maintained using the LIDAR sensor 1 during a second journey in the opposite direction.

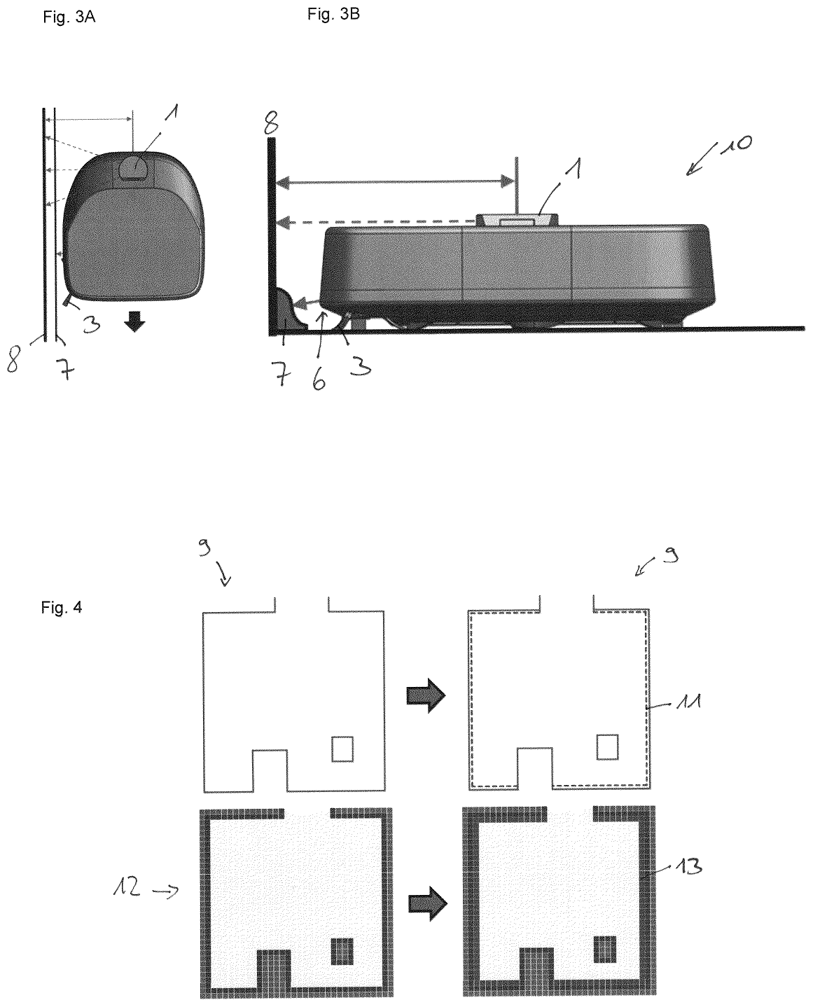

A first method step in order to enable collision-free travelling in both directions along walls using only a single wall tracking sensor 6, in particular in order to ensure effective carpet cleaning, is shown in FIGS. 3A and 3B. The appliance 10 travels along a wall section 8 for the first time with the side brush side, i.e. in particular with the right-hand side in the direction of travel, on which the wall tracking sensor 6 is also disposed and is preferably positioned close to the floor and inclined downwards on the appliance 10. The appliance 10 maintains a first distance to the wall 8 or an existing baseboard 7 according to the measured values of the wall tracking sensor. The LIDAR sensor 1 also simultaneously measures a second distance to the wall, so that the distance to the actual wall that the appliance 10 must maintain can be determined for each point of the wall section 8. A difference between the simultaneous distance values of the wall tracking sensor 6 and the LIDAR sensor 1 is determined by a computer facility 14 of the appliance 10, on the basis of which a collision-free distance value with respect to the wall section is determined for a closed-loop distance control.

The collision-free distance value that is determined is entered into an existing map 9 of the surroundings of the appliance 10, as shown in FIG. 4. In particular, new lines 11 are drawn into the map of the surroundings; the new lines correspond to the collision-free distance value that is determined and they must not be crossed by the appliance 10 during cleaning journeys. Wall sections in which the appliance has not detected any objects close to the floor remain unchanged.

Next to the environment map 9, FIG. 4 shows an alternative grid map 12, in which grid lines 13 are entered based on the collision-free distance value that is determined, the grid lines indicate objects at floor level and are labeled accordingly as impassable. The appliance 10 no longer travels over these grid lines.

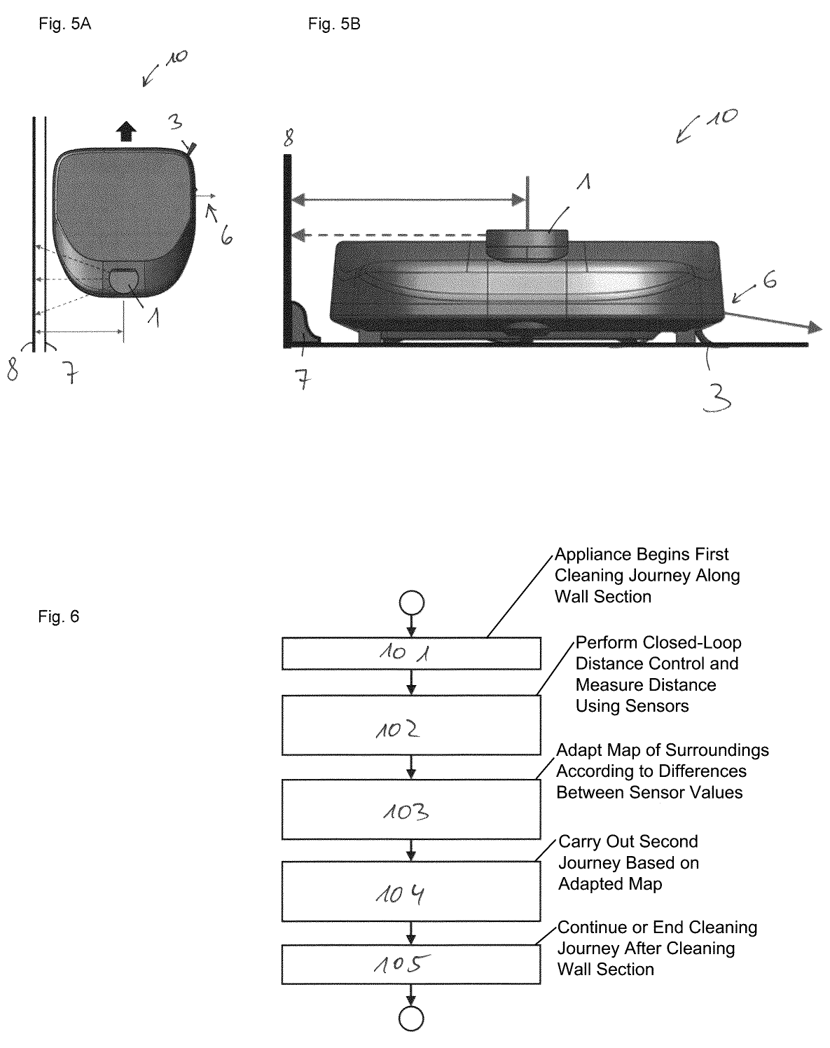

If the appliance 10 is to travel along the wall section one more time and in the opposite direction, i.e. mirror-inverted, because there is a carpet there, for example, the appliance 10 accesses the adapted and expanded map of the surroundings, in which the collision-free distance value that is determined is entered. Using the LIDAR sensor 1, the distance to the wall 8 is maintained in such a way that the areas previously classified as non-passable are omitted and no collision occurs even without the wall tracking sensor 6, while the appliance 10 still moves as close to the wall as possible, as shown in FIGS. 5A and 5B. For example, the appliance therefore travels along the wall at a second distance during the return journey.

Preferably, the appliance 10 marks sections of the wall in the map of the surroundings in which carpet areas reach right up to the wall. Travelling in both directions along wall sections can then be restricted to these areas.

FIG. 6 shows the basic procedure for determining the collision-free distance value. In step 101, the appliance 10 begins its cleaning journey. During a first journey along a wall section 8, the closed-loop distance control is performed by the wall tracking sensor while simultaneously measuring the distance by using the LIDAR sensor 1 (step 102). After determining the collision-free distance value that is required for a collision-free journey, the map of the surroundings is adapted with new lines or edges according to the difference between the distance values of the wall-tracking sensor 6 and the LIDAR sensor 1 (step 103). During a second journey along the same section of wall, the closed-loop distance control is only performed by the LIDAR sensor 1 based on the adapted map of the surroundings, which is based on the collision-free distance value that is determined (step 104). In step 105, the appliance continues or ends its cleaning journey after cleaning the wall section.

The procedure for determining the collision-free distance value can be repeated for each first journey along wall sections. Alternatively, such a procedure can only take place during an initial exploration of the appliance. However, if a new collision is detected and thus a change compared to the existing map of the surroundings is determined, the first journey along the wall section, including the adaptation of the map of the surroundings, is performed again.

1. A method for at least one of collision-free wall cleaning or collision-free edge cleaning using a mobile, self-driving appliance or a floor cleaning appliance or a robotic vacuum, sweeping or mopping robot, for autonomous processing of floor surfaces, the method comprising:
providing a laterally disposed wall tracking sensor and a distance sensor on the appliance;
moving the appliance along a section of a wall at a first distance from the wall determined by measured values of the wall tracking sensor;
simultaneously measuring a second distance from the wall using the distance sensor;
using a computer facility of the appliance to determine a difference between distance values of the wall tracking sensor and the distance sensor;
determining a collision-free distance value with respect to the wall section as a function of the difference determined by the computer facility; and
using a closed-loop distance control to control subsequent cleaning journeys as a function of the determined collision-free distance value.

2. The method according to claim 1, which further comprises providing the wall tracking sensor on one side of the appliance.

3. The method according to claim 1, which further comprises providing the wall tracking sensor on one side of the appliance, and not providing a wall tracking sensor on an opposite side of the appliance.

4. The method according to claim 1, which further comprises determining the collision-free distance value from determined minimum distances of measurements of the wall tracking sensor and the distance sensor.

5. The method according to claim 1, which further comprises recording the collision-free distance value in a map of surroundings or a grid map.

6. The method according to claim 5, which further comprises recording revised boundary lines or delimiting grid lines that the appliance should not pass over, in the map of the surroundings or the grid map.

7. The method according to claim 1, which further comprises only using the distance sensor for the closed-loop distance control during subsequent cleaning journeys.

8. The method according to claim 1, which further comprises only performing a measurement using the wall tracking sensor on an outward journey, and only performing measurements using the distance sensor on a return journey.

9. The method according to claim 8, which further comprises carrying out the outward and return journeys in areas in which a floor carpet is adjacent to a wall.

10. The method according to claim 1, which further comprises determining the collision-free distance value during an exploratory journey of the appliance.

11. The method according to claim 5, which further comprises determining a collision-free distance value during cleaning journeys of the appliance, only upon determining a change compared to an existing map of the surroundings or grid map.
